(19) United States
(12) Patent Application Publication
(10) Pub. No.: US 2021/0077959 A1
(43) Pub. Date: Mar. 18, 2021

(54) PADDLE MIXER

(71) Applicant: Honey Creek Innovations, LLC, Honey Creek, IA (US)

(72) Inventors: Michael Wayne Graham, Omaha, NE (US); Leonard Clyde Graham, Honey Creek, IA (US)

(73) Assignee: Honey Creek Innovations, LLC, Honey Creek, IA (US)

(21) Appl. No.: 17/024,412

(22) Filed: Sep. 17, 2020

Related U.S. Application Data
(60) Provisional application No. 62/902,029, filed on Sep. 18, 2019.

(51) Int. Cl. B01F 7/00; B01F 13/00

(52) U.S. Cl. CPC B01F 7/003; B01F 7/00633; B01F 13/0028

(57) ABSTRACT

A paddle mixer for evenly and efficiently mixing a volume of aggregate with minimal spillage is described. The paddle mixer includes a first portion, a second portion, a first paddle, and a second paddle. The paddle mixer may include a means for adjustably fixing the first portion to the second portion. The first paddle and the second paddle are arranged on the first portion and the second portion, respectively, such that the first paddle and the second paddle are perpendicular to each other, promoting mixing of the volume of aggregate with a whirlpool effect allowing mixing with minimal spillage. The first paddle and the second paddle may also be arranged perpendicular to each other by the means for adjustably fixing the first portion and the second portion.

### REFERENCE TO RELATED APPLICATIONS

This application claims the benefit of U.S. Provisional Application No. 62/902,029 entitled “PADDLE MIXER” filed Sep. 18, 2019, which is incorporated by reference in its entirety.

### BACKGROUND

Mixing aggregate evenly and efficiently into a solution, colloid, or suspension increases the ease of use of the solution, colloid, or suspension, as well the integrity of the solution, colloid, or suspension, or the final product in which the solution, colloid, or suspension is used (e.g., concrete, paint, or the like). In order to evenly mix a volume of aggregate into a solution, colloid, or suspension, the aggregate must be thoroughly combined with another volume, such as a liquid matrix, such that the aggregate is mixed throughout the volume in a uniform consistency.

Conventional apparatuses for mixing aggregate include manual mixers, such as a rod or stick that a user engages to stir the volume of aggregate into the liquid matrix. Conventional apparatuses further include mechanically powered mixers, such as mixers attached to the end of power drill. However, these conventional apparatuses present practical limitations that prevent even and efficient mixing with minimal spillage.

Manual apparatuses lack the ability to mix evenly and efficiently because they rely on manual power (e.g., stirring by hand). Manual mixers and powered mixers frequently require addition of the aggregate to the volume in small amounts over time, where the small amount of volume is mixed into the liquid matrix before the next small amount of aggregate volume is added. This requires a user to engage in a stop-and-go method of mixing, decreasing the ability to efficiently mix the aggregate. Further, this stop-and-go mixing further decreases the ability to mix the volume of aggregate evenly, as the aggregate is added at different times leading to different consistency states of the solution, colloid, or suspension as aggregate is added.

Mixing of aggregate using manual and mechanically powered apparatuses frequently results in spillage of the volume of aggregate—that is, splashing or overflow from the container in which the aggregate is mixed. Spillage leads to a loss of aggregate and liquid matrix and an uneven mixing, as these components are typically not lost in equal proportion. Spillage also leads to the undesirable loss of overall volume of the solution, colloid, or suspension.

Manual and mechanically powered apparatuses for mixing aggregate lack durability and are prone to deterioration and breakage. When moved within aggregate, conventional mixers encounter fluid resistance and drag within the aggregate. The fluid resistance and drag are often of such strength that conventional apparatuses may break or deteriorate quickly through repeated use.

It is therefore desirable to have a paddle mixer for evenly mixing aggregate. It is further desirable to have a paddle mixer that efficiently mixes aggregate because it is configured to reduce the amount of time required to evenly mix such aggregate within a volume—such as through its abilities to mix large quantities of aggregate at a time, and to prevent spillage. It is further desirable to have a paddle mixer that is configured maintain structural integrity when subject to the fluid resistance and reduce drag within the aggregate, such that the paddle mixer is durable and resistant to breakage and deterioration through repeated use.

### FIGURES

FIG. 1 illustrates a perspective view of a paddle mixer.

FIG. 2a represents a front view of a paddle mixer.

FIG. 2b represents a right-side view of a paddle mixer.

FIG. 2c represents a back view of a paddle mixer.

FIG. 2d represents a left-side view of a paddle mixer.

FIG. 3 represents a top-down view of a paddle mixer.

### SUMMARY

In aspects, the paddle mixer includes a first portion; a second portion; a means for adjustably fixing the first portion to the second portion; a first paddle in fixed communication with the first portion, the first paddle comprising a first paddle first vertical piece having four first paddle first vertical piece holes, where the first paddle first vertical piece is in mechanical communication with a first paddle horizontal piece, the first paddle horizontal piece, where the first paddle horizontal piece is in mechanical communication with a first paddle second vertical piece, and the first paddle second vertical piece having four first paddle second vertical piece holes; and a second paddle in fixed communication with the second portion, the second paddle comprising a second paddle first vertical piece having four second paddle first vertical piece holes, where the second paddle first vertical piece is in mechanical communication with a second paddle horizontal piece, the second paddle horizontal piece, where the second paddle horizontal piece is in mechanical communication with a second paddle second vertical piece, and the second paddle second vertical piece having four second paddle second vertical piece holes.

In other aspects of the invention, the paddle mixer includes a first portion; a second portion, where the first portion is adjustability fixed to the second portion via a mechanism selected from the group consisting of a pin-and-clip mechanism, a bolt-and-nut mechanism, or a bolt-and-washer mechanism; a first paddle in fixed communication with the first portion, the first paddle comprising a first paddle first vertical piece having four first paddle first vertical piece holes, where the first paddle first vertical piece is in mechanical communication with a first paddle horizontal piece, the first paddle horizontal piece, where the first paddle horizontal piece is in mechanical communication with a first paddle second vertical piece, and the first paddle second vertical piece having four first paddle second vertical piece holes; and a second paddle in fixed communication with the second portion, the second paddle comprising a second paddle first vertical piece having four second paddle first vertical piece holes, where the second paddle first vertical piece is in mechanical communication with a second paddle horizontal piece, the second paddle horizontal piece, where the second paddle horizontal piece is in mechanical communication with a second paddle second vertical piece, and the second paddle second vertical piece having four second paddle second vertical piece holes.

In other aspects of the invention the paddle mixer includes a first portion; a second portion, where the first portion is adjustability fixed to the second portion via a mechanism selected from the group consisting of a pin-and-clip mechanism, a bolt-and-nut mechanism, or a bolt-and-washer mechanism; a first paddle in fixed communication with the first portion, the first paddle comprising a first paddle first vertical piece having four first paddle first vertical piece holes, where the first paddle first vertical piece is in mechanical communication with a first paddle horizontal piece at an angle of approximately 90 degrees, the first paddle horizontal piece, where the first paddle horizontal piece is in mechanical communication with a first paddle second vertical piece at an angle of approximately 90 degrees, and the first paddle second vertical piece having four first paddle second vertical piece holes; and a second paddle in fixed communication with the second portion, the second paddle comprising a second paddle first vertical piece having four second paddle first vertical piece holes, where the second paddle first vertical piece is in mechanical communication with a second paddle horizontal piece at an angle of approximately 90 degrees, the second paddle horizontal piece, where the second paddle horizontal piece is in mechanical communication with a second paddle second vertical piece at an angle of approximately 90 degrees, and the second paddle second vertical piece having four second paddle second vertical piece holes.

### DETAILED DESCRIPTION

A paddle mixer for evenly and efficiently mixing a volume of aggregate with minimal spillage is described. The paddle mixer includes a first portion, a second portion, a first paddle, and a second paddle. The paddle mixer may include a means for adjustably fixing the first portion to the second portion. The first paddle includes a first paddle first vertical piece having first paddle first vertical piece holes, a first paddle horizontal piece, and a first paddle second vertical piece having second paddle second vertical piece holes that promote evenly and efficiently mixing of the volume of aggregate with minimal spillage. The second paddle includes a second paddle first vertical piece having second paddle first vertical piece holes, a second paddle horizontal piece, and a second paddle second vertical piece having second paddle second vertical piece holes that promote evenly and efficiently mixing of the volume of aggregate with minimal spillage.

The first paddle and the second paddle are arranged on the first portion and the second portion, respectively, such that the first paddle and the second paddle are perpendicular to each other, promoting mixing of the volume of aggregate with a whirlpool effect allowing mixing with minimal spillage. The first paddle and the second paddle may also be arranged perpendicular to each other by the means for adjustably fixing the first portion and the second portion. The paddle mixer is configured for insertion into a container that holds the volume of aggregate, such as a bucket.

As used herein, evenly mixing a volume of aggregate means the blending of the aggregate to produce a solution, colloid, or suspension where the aggregate is distributed equally throughout the solution, colloid, or suspension. For example, as used herein efficient mixing, means mixing a 27.3 kilogram (60 pound) bag of a volume of aggregate (in this example concrete) in 60 seconds or less. As used herein, minimal spillage means that the volume of aggregate stays within the container in which it is held. As used herein a volume of aggregate means fluid cement with concrete aggregate, paint with paint pigment, and other mixture or solutions containing aggregate. As used herein whirlpool effect means the volume of aggregate rotating in the container producing a vortex having a downdraft.

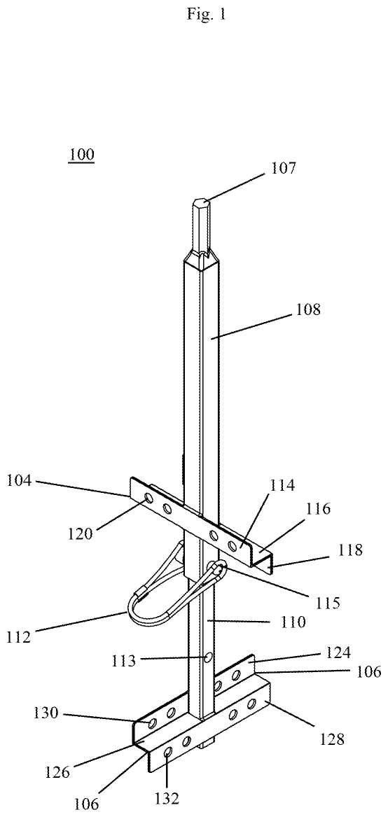

FIG. 1 is a perspective view of a paddle mixer 100. The paddle mixer 100 includes a first portion 108, a second portion 110, a first paddle 104, a second paddle 106, and may include a means 112 for adjustably fixing the first portion 108 to the second portion 110.

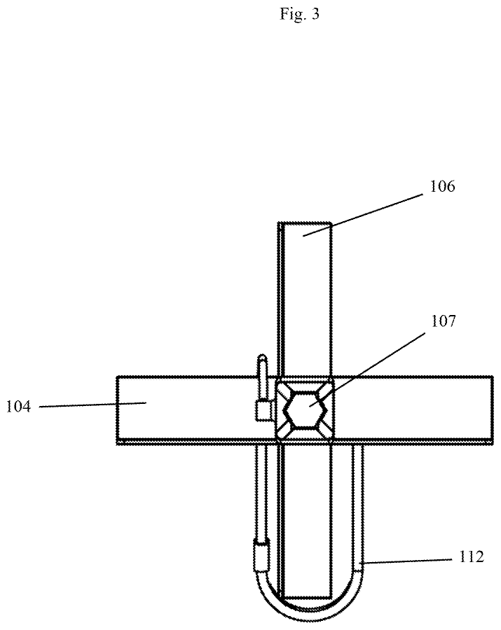

The first portion 108 provides for fixed attachment of the first paddle 104. The first portion 108 may be cylindrical, cubical, or triangular in shape and may include a hollow channel for receiving the second portion 110. The first portion 108 may be of a width (or diameter) smaller than that of the second portion 110 such that the first portion 108 may be received by a hollow channel of the second portion 110. The first portion 108 may be of a width (or diameter) larger than that of the second portion 110 such that the second portion 108 may be received by a hollow channel of the first portion 108. The first portion 108 includes an attachment head 107 for attachment to a drill or other power tool (see FIG. 3), where the attachment head 107 prevents slipping of the attachment head 107 within the drill or other power tool. The attachment head 107 may be a hex head. The first portion 108 may be made of any rigid, non-corrosive material, such as metal, metal alloys, high-density polyethylene, or the like.

The second portion 110 provides for fixed attachment of the second paddle 106. The second portion 110 may be cylindrical, cubical, or triangular in shape and may be of a width (or diameter) larger than that of the first portion 108 such that the first portion 108 may be received by a hollow channel of the second portion 110. The second portion 110 may be of a width (or diameter) smaller than that of the first portion 108 such that the second portion 110 may be received by a hollow channel of the first portion 108. The second portion 110 may contain a hollow channel for receiving the first portion 110. The first portion 108 and the second portion 110 may be formed as a single piece. The second portion 110 may be made of any rigid, non-corrosive material, such as metal, metal alloys, polycarbonate, or the like. Preferably the material is mild steel.

The means 112 for adjustably fixing the first portion 108 to the second portion 110 may be a pin-and-clip mechanism, a bolt-and-washer mechanism, a bolt-and-nut mechanism. The means 112 for adjustably fixing the first portion 108 and the second portion 110 may include one or more holes 113 on the second portion 110 configured to receive a pin-and-clip, bolt-and-washer, or bolt-and-nut. The means 112 for adjustably fixing the first portion 108 and the second portion 110 may include a hole 115 on the first portion 110 configured to receive a pin-and-clip, bolt-and-washer, or bolt-and-nut. The means 112 for adjustably fixing the first portion 108 and the second portion 110 allows for arrangement of the first paddle 104 and the second paddle 106 in a perpendicular manner.

The means 112 for adjustably fixing the first portion 108 to the second portion 110 allows the distance between the first paddle 104 and the second paddle 106 to be increased or decreased to a distance that allows the creation of a whirlpool effect when mixing a determined volume of aggregate to provide even, efficient mixing of the volume of aggregate with minimal spillage. The distance between the first paddle 104 and the second paddle 106 may be determined by the properties and volume of aggregate to be mixed through the use of the paddle mixer 100, including the type of aggregate, and the size of the components of the aggregate. The distance between the first paddle 104 and the second paddle 106 may be adjusted for use in containers of varying size.

The means 112 for adjustably fixing the first portion 108 to the second portion 110 allows the first paddle 104 and the second paddle 106 to arrange in a parallel manner, so that the paddle mixer 100 lays flat for storage and transport. This parallel manner arrangement decreases the risk of damage to the paddle mixer 100 during storage and transport.

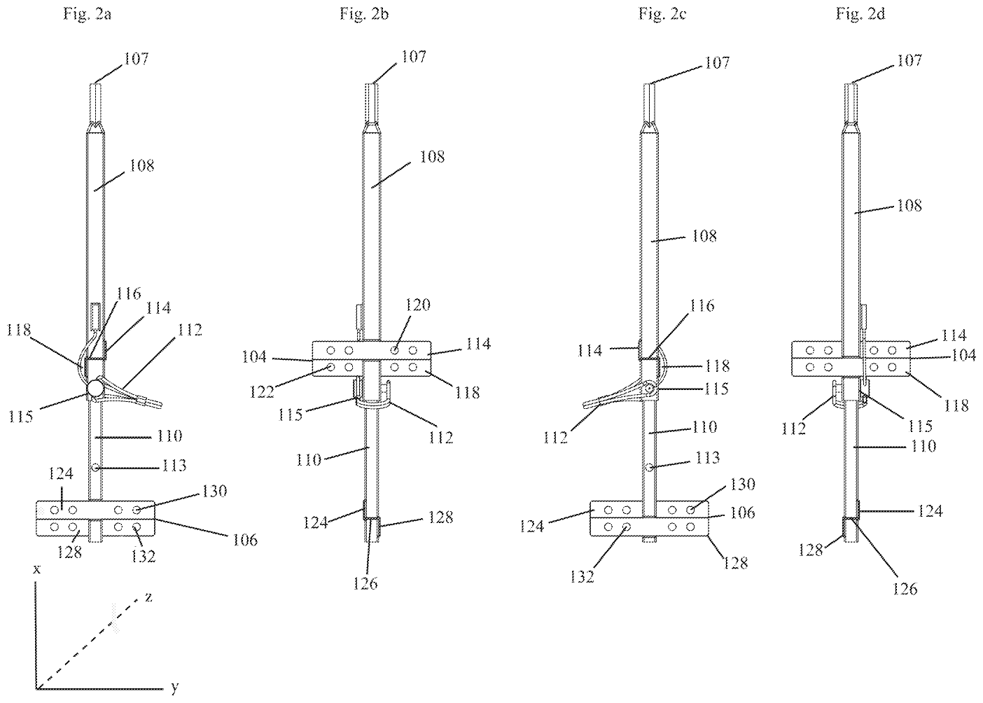

FIG. 2a shows a front view of the first paddle 104, and FIG. 2c shows the back view of the first paddle 104. The first paddle 104 is fixedly attached to the first portion 110, such as through welding, bolts, screws, or the like. The first paddle 104 is configured to evenly and efficiently mix a volume of aggregate. The first paddle 104 includes a first paddle first vertical piece 114, a first paddle horizontal piece 116, and a first paddle second vertical piece 118.

The first paddle first vertical piece 114 is in mechanical communication with the first paddle horizontal piece 116 such that the first paddle first vertical piece 114 and the first paddle horizontal piece 116 form an angle of approximately 90 degrees, where approximately 90 degrees means 90 degrees±5 degrees. The first paddle horizontal piece 116 is in mechanical communication with the first paddle second vertical piece 118 such that the first paddle horizontal piece 116 and the first paddle second vertical piece 118 form an angle of approximately 90 degrees, where approximately 90 degrees means 90 degrees±5 degrees. This arrangement of the first paddle first vertical piece 114, the first paddle horizontal piece 116, and the first paddle second vertical piece 118 provides structural integrity to the first paddle 104, such that the first paddle 104 is not bent or deformed during mixing.

The first paddle 104 is formed from any rigid, non-corrosive material, such as metal, metal alloys, high-density polyethylene, or the like. The first paddle 104 may be formed from a single piece of rigid material. The shape of the first paddle 104, including the slightly rounded corners of the first paddle first vertical piece 114 and the first paddle second vertical piece 118, allows the volume of aggregate to be mixed evenly and efficiently and with minimal spillage as the paddle mixer can maneuver against the walls of a circular container holding the volume of aggregate. The shape of the first paddle 104, including the approximately 90 degree angles thereof, permits the first paddle 104 to be rigid and to maintain its configuration despite being subjected to fluid resistance when the paddle mixer 100 rotated about the z-axis in a volume of aggregate.

The first paddle first vertical piece 114 is approximately 12.38 centimeters in length, where approximately 12.38 centimeters in length means 12.38 centimeters±6 centimeters, approximately 1.91 centimeters in height, where approximately 1.91 centimeters in height means 1.91 centimeters±2 centimeters, and approximately 1.6 centimeters in thickness, where approximately 1.6 centimeters means 1.6 centimeters±1 centimeters. The first paddle first vertical piece 114 includes four first paddle first vertical piece holes 120.

The first paddle first vertical piece holes 120, when rotated about the z-axis in a volume of aggregate, reduce drag and fluid resistance within the volume of aggregate by permitting the volume of aggregate to flow through the first paddle first vertical piece 114, thereby reducing fluid resistance on the first paddle 104. The reduction in drag caused by the first paddle first vertical piece holes 114 increases the speed of rotation of the paddle mixer 100 as compared to a first paddle first vertical piece 114 lacking first paddle first vertical piece holes 120, and thereby reduces the time required for sufficient mixing. The flow of the volume of aggregate through the first paddle first vertical piece holes 120 assists in creating a whirlpool effect in the volume of aggregate.

The first paddle first vertical piece holes 120 are openings in the first paddle first vertical piece 114, and may be formed as circular, rectangular, ovular shapes, or as a combination thereof. The first paddle first vertical piece holes 120 may be arranged in pairs on the first paddle first vertical piece 114. When arranged as pairs, the first paddle first vertical piece holes 120 of each pair are approximately 1.9 centimeters apart, where approximately 1.9 centimeters means 1.9 centimeters±1 centimeter. The placement of the first paddle first vertical piece holes 120 assists in creating the whirlpool effect.

The first paddle horizontal piece 116 is approximately 12.38 centimeters in length, where approximately 12.38 centimeters in length means 12.38 centimeters±6 centimeters, approximately 1.44 centimeters in height, where approximately 1.44 centimeters in height means 1.44 centimeters±2 centimeters, and approximately 1.6 centimeters in thickness, where approximately 1.6 centimeters means 1.6 centimeters±1 centimeters.

The first paddle second vertical piece 118 is approximately 12.38 centimeters in length, where approximately 12.38 centimeters in length means 12.38 centimeters±6 centimeters, approximately 1.91 centimeters in height, where approximately 1.91 centimeters in height means 1.91 centimeters±2 centimeters, and approximately 1.6 centimeters in thickness, where approximately 1.6 centimeters means 1.6 centimeters±1 centimeters. The first paddle second vertical piece 118 includes four first paddle second vertical piece holes 122.

The first paddle second vertical piece holes 122, when rotated about the z-axis in a volume of aggregate, reduce drag and fluid resistance within the volume of aggregate by permitting the volume of aggregate to flow through the first paddle second vertical piece 118, thereby reducing fluid resistance on the first paddle 104. The reduction in drag caused by the first paddle second vertical piece holes 122 increases the speed of rotation of the paddle mixer 100, and thereby reduces the time required for sufficient mixing. The flow of the volume of aggregate through the first paddle second vertical piece holes 122 assists in creating a whirlpool effect in the volume of aggregate.

The first paddle second vertical piece holes 122 are openings in the first paddle second vertical piece 118, and may be formed as circular, rectangular, ovular shapes, or as a combination thereof. The first paddle second vertical piece holes 122 may be arranged in pairs on the first paddle second vertical piece 118. When arranged as pairs, the first paddle second vertical piece holes 122 of each pair are approximately 1.9 centimeters apart, where approximately 1.9 centimeters means 1.9 centimeters±1 centimeters. The placement of the first paddle second vertical piece holes 122 assists in creating the whirlpool effect.

FIG. 2b shows a front view of the second paddle 106, and FIG. 2d shows the back view of the second paddle 106. The second paddle 106 is fixedly attached to the second portion 112, such as through welding, bolts, screws, or the like. The second paddle 106 includes a second paddle first vertical piece 124, a second paddle horizontal piece 126, and a second paddle second vertical piece 128. The second paddle first vertical piece 124 is in mechanical communication with the second paddle horizontal piece 126 such that the second paddle second vertical piece 120 and the second paddle horizontal piece 126 form an angle of approximately 90 degrees, where approximately 90 degrees means 90 degrees±5 degrees. The second paddle horizontal piece 126 is in mechanical communication with the second paddle second vertical piece 128 such that the second paddle horizontal piece 126 and the second paddle second vertical piece 128 form an angle of approximately 90 degrees, where approximately 90 degrees means 90 degrees±5 degrees. This arrangement of the second paddle first vertical piece 124, the second paddle horizontal piece 126, and the first paddle second vertical piece 128 provides structural integrity to the second paddle 106, such that the second paddle 106 is not bent or deformed during mixing.

The second paddle 106 is formed from any rigid, non-corrosive material, such as metal, metal alloys, high-density polyethylene, or the like. The second paddle 106 may be formed from a single piece of rigid material. The shape of the second paddle 106, including the slightly rounded corners of the second paddle first vertical piece 124 and the second paddle second vertical piece 128, allows the volume of aggregate to be mixed evenly and efficiently and with minimal spillage as the paddle mixer can maneuver against the walls of a circular container holding the volume of aggregate. The shape of the second paddle 106, including the approximately 90 degree angles thereof, permits the second paddle 106 to be rigid and to maintain its configuration despite being subjected to fluid resistance when the paddle mixer 100 is rotated about the z-axis in a volume of aggregate.

The second paddle first vertical piece 124 is approximately 12.38 centimeters in length, where approximately 12.38 centimeters in length means 12.38 centimeters±6 centimeters, approximately 1.91 centimeters in height, where approximately 1.91 centimeters in height means 1.91 centimeters±2 centimeters, and approximately 1.6 centimeters in thickness, where approximately 1.6 centimeters means 1.6 centimeters±1 centimeters.

The second paddle first vertical piece 124 includes four second paddle first vertical piece holes 130. The second paddle first vertical piece holes 130 are openings in the second paddle first vertical piece 124, and may be formed as circular, rectangular, ovular shapes, or as a combination thereof. The second paddle first vertical piece holes 130 may be arranged in pairs on the second paddle first vertical piece 124. When arranged as pairs, the second paddle first vertical piece holes 130 of each pair are approximately 1.9 centimeters apart, where approximately 1.9 centimeters means 1.9 centimeters±1 centimeters. The placement of the second paddle first vertical piece holes 124 assists in creating the whirlpool effect.

The second paddle first vertical piece holes 130, when rotated about the z-axis in a volume of aggregate, reduce drag and fluid resistance within the volume of aggregate by permitting the volume of aggregate to flow through the second paddle first vertical piece 124, thereby reducing fluid resistance on the second paddle 106. The reduction in drag caused by the second paddle first vertical piece holes 124 increases the speed of rotation of the paddle mixer 100, and thereby reduces the time required for sufficient mixing. The flow of the volume of aggregate through the second paddle first vertical piece holes 130 assists in creating a whirlpool effect in the volume of aggregate.

The second paddle horizontal piece 126 is approximately 12.38 centimeters in length, where approximately 12.38 centimeters in length means 12.38 centimeters±6 centimeters, approximately 1.44 centimeters in height, where approximately 1.44 centimeters in height means 1.44 centimeters±2 centimeters, and approximately 1.6 centimeters in thickness, where approximately 1.6 centimeters means 1.6 centimeters±1 centimeters.

The second paddle second vertical piece 128 is approximately 12.38 centimeters in length, where approximately 12.38 centimeters in length means 12.38 centimeters±6 centimeters, approximately 1.91 centimeters in height, where approximately 1.91 centimeters in height means 1.91 centimeters±2 centimeter, and approximately 1.6 centimeters in thickness, where approximately 1.6 centimeters means 1.6 centimeters±1 centimeters. The second paddle second vertical piece 128 includes four second paddle second vertical piece holes 132.

The second paddle second vertical piece holes 132 are openings in the second paddle second vertical piece 128, and may be formed as circular, rectangular, ovular shapes, or as a combination thereof. The second paddle second vertical piece holes 132 may be arranged in pairs on the second paddle second vertical piece 128. When arranged as pairs, the second paddle second vertical piece holes 132 of each pair are approximately 1.9 centimeters apart, where approximately 1.9 centimeters means 1.9 centimeters±1 centimeter. The placement of the second paddle second vertical piece holes 132 assists in creating the whirlpool effect.

The second paddle second vertical piece holes 132, when rotated about the z-axis in a volume of aggregate, reduce drag and fluid resistance within the volume of aggregate by permitting the volume of aggregate to flow through the second paddle third vertical piece 128, thereby reducing fluid resistance on the second paddle 106. The reduction in drag caused by the second paddle second vertical piece holes 132 increases the speed of rotation of the paddle mixer 100, and thereby reduces the time required for sufficient mixing. The flow of the volume of aggregate through the second paddle second vertical piece holes 132 assists in creating the whirlpool effect.

FIG. 3 represents a top-down view of the paddle mixer 100, where the first paddle 104 is perpendicular to the second paddle 106. The perpendicular orientation of the first paddle 104 relative to the second paddle 106 assists in creating a whirlpool effect to evenly and efficiently mix the volume of aggregate. During use the paddle mixer 100 is rotated about the z-axis in a volume of aggregate. The paddle mixer 100 may be moved in the x and y axis.

1. A paddle mixer comprising:
a first portion;
a second portion;
a means for adjustably fixing the first portion to the second portion;
a first paddle in fixed communication with the first portion, the first paddle comprising
a first paddle first vertical piece having four first paddle first vertical piece holes, where
the first paddle first vertical piece is in mechanical communication with a first paddle horizontal piece,
the first paddle horizontal piece, where
the first paddle horizontal piece is in mechanical communication with a first paddle second vertical piece, and
the first paddle second vertical piece having four first paddle second vertical piece holes; and
a second paddle in fixed communication with the second portion, the second paddle comprising
a second paddle first vertical piece having four second paddle first vertical piece holes, where
the second paddle first vertical piece is in mechanical communication with a second paddle horizontal piece,
the second paddle horizontal piece, where
the second paddle horizontal piece is in mechanical communication with a second paddle second vertical piece, and
the second paddle second vertical piece having four second paddle second vertical piece holes.

2. The paddle mixer of claim 1, wherein
the first paddle and the second paddle are made from a rigid, non-corrosive material.

3. The paddle mixer of claim 1, wherein
the first portion includes a hex head for attachment to a power tool.

4. The paddle mixer of claim 1, wherein
first paddle first vertical piece and the first paddle horizontal piece are in mechanical communication at an angle of approximately 90 degrees.

5. The paddle mixer of claim 1, wherein
the first paddle horizontal piece and the first paddle second vertical piece are in mechanical communication at an angle of approximately 90 degrees.

6. The paddle mixer of claim 1, wherein
the second paddle first vertical piece and the second paddle horizontal piece are in mechanical communication at angle of approximately 90 degrees.

7. The paddle mixer of claim 1, wherein
the second paddle horizontal piece and the second paddle second vertical piece are in mechanical communication at an angle of approximately 90 degrees.

8. The paddle mixer of claim 1, wherein
the first paddle first vertical piece holes are of a shape selected from the group consisting of circular, ovular, and rectangular, and combinations thereof.

9. The paddle mixer of claim 1, wherein
the first paddle second vertical piece holes are of a shape selected from the group consisting of circular, ovular, rectangular, and combinations thereof.

10. The paddle mixer of claim 1, wherein
the second paddle first vertical piece holes are of a shape selected from the group consisting of circular, ovular, and rectangular, and combinations thereof.

11. The paddle mixer of claim 1, wherein
the second paddle second vertical piece holes are of a shape selected from the group consisting of circular, ovular, and rectangular, and combinations thereof.

12. The paddle mixer of claim 1, wherein
the first paddle is perpendicular to the second paddle.

13. A paddle mixer comprising:
a first portion;
a second portion, where the first portion is adjustability fixed to the second portion via a mechanism selected from the group consisting of a pin-and-clip mechanism, a bolt-and-nut mechanism, or a bolt-and-washer mechanism;
a first paddle in fixed communication with the first portion, the first paddle comprising
a first paddle first vertical piece having four first paddle first vertical piece holes, where
the first paddle first vertical piece is in mechanical communication with a first paddle horizontal piece,
the first paddle horizontal piece, where
the first paddle horizontal piece is in mechanical communication with a first paddle second vertical piece, and
the first paddle second vertical piece having four first paddle second vertical piece holes; and
a second paddle in fixed communication with the second portion, the second paddle comprising
a second paddle first vertical piece having four second paddle first vertical piece holes, where
the second paddle first vertical piece is in mechanical communication with a second paddle horizontal piece,
the second paddle horizontal piece, where
the second paddle horizontal piece is in mechanical communication with a second paddle second vertical piece, and
the second paddle second vertical piece having four second paddle second vertical piece holes.

14. A paddle mixer comprising:
a first portion;
a second portion, where
the first portion is adjustability fixed to the second portion via a mechanism selected from the group consisting of a pin-and-clip mechanism, a bolt-and-nut mechanism, or a bolt-and-washer mechanism;
a first paddle in fixed communication with the first portion, the first paddle comprising a first paddle first vertical piece having four first paddle first vertical piece holes, where
the first paddle first vertical piece is in mechanical communication with a first paddle horizontal piece at an angle of approximately 90 degrees,
the first paddle horizontal piece, where
the first paddle horizontal piece is in mechanical communication with a first paddle second vertical piece at an angle of approximately 90 degrees, and
the first paddle second vertical piece having four first paddle second vertical piece holes; and
a second paddle in fixed communication with the second portion, the second paddle comprising
a second paddle first vertical piece having four second paddle first vertical piece holes, where
the second paddle first vertical piece is in mechanical communication with a second paddle horizontal piece at an angle of approximately 90 degrees,
the second paddle horizontal piece, where
the second paddle horizontal piece is in mechanical communication with a second paddle second vertical piece at an angle of approximately 90 degrees, and
the second paddle second vertical piece having four second paddle second vertical piece holes.
